(19) United States
(12) Patent Application Publication
(10) Pub. No.: US 2024/0389567 A1
(43) Pub. Date: Nov. 28, 2024

(54) Fly Fishing System

(71) Applicant: Lorin Gardner, Nampa, ID (US)

(72) Inventor: Lorin Gardner, Nampa, ID (US)

(21) Appl. No.: 18/460,771

(22) Filed: Sep. 5, 2023

Related U.S. Application Data
(60) Provisional application No. 63/504,330, filed on May 25, 2023.

(51) Int. Cl. A01K 97/08; A01K 87/02; A01K 89/016

(52) U.S. Cl. CPC A01K 97/08; A01K 87/025; A01K 89/016

(57) ABSTRACT

A fly fishing system is provided comprised of a body that can receive a fly fishing reel. The body can be secured to a belt of a user when in use such that the reel is supported without the use of the user's hands. In addition, the system is comprised of a telescopic fly fishing rod that is hollow such that a fishing line can be fed through the rod without the need for guides/eyelets found on traditional fly fishing rods. When not in use, the rod can be collapsed and stored on the body.

### CROSS-REFERENCE TO RELATED APPLICATION

The present application claims priority to, and the benefit of, U.S. Provisional Application No. 63/504,330, which was filed on May 25, 2023, and is incorporated herein by reference in its entirety.

### FIELD OF THE INVENTION

The present invention relates generally to the field of fly fishing. More specifically, the present invention relates to a fly fishing system comprised of a body that can be worn on a belt of a user that suspends a reel and that also stores a telescopic fly fishing rod when not in use. Accordingly, the present disclosure makes specific reference thereto. Nonetheless, it is to be appreciated that aspects of the present invention are also equally applicable to other like applications, devices, and methods of manufacture.

### BACKGROUND

Fly fishing presents a unique set of challenges that fly fishermen must contend with. One such challenge arises from the necessity of holding a fly reel, which occupies at least one hand, inevitably leaving only one hand available for other essential tasks. This limitation can become a source of frustration for anglers seeking to multitask or manage their fishing gear efficiently.

In addition, without a practical carrying device, fly fishermen are left with little choice but to carry their rod awkwardly in one hand while trying to navigate the surroundings with the other. This cumbersome and unbalanced arrangement can significantly hinder their ability to traverse rough terrains or engage in other activities while on a fishing expedition. Improper handling and storage during travel can lead to unfortunate accidents, such as bent or broken guides, which can severely impact the rod's performance and overall fishing experience.

Furthermore, preparing fly fishing rods for use adds another layer of complexity to the experience. Threading a fishing line through the miniature guides of a fly rod can be a time-consuming and delicate task, requiring a deft touch and keen attention to detail. The repetitive action of guiding the line through these tiny openings can test even the most patient of anglers.

Therefore, there exists a long-felt need in the art for a fly fishing system. More specifically, there exists a long-felt need in the art for a fly fishing system that eliminates the need for a user to hold a fly reel while fly fishing. In addition, there exists a long-felt need in the art for a fly fishing system that ensures a fly reel is secure during use. Further, there exists a long-felt need in the art for a fly fishing system to have a fly fishing rod that is easily transportable. Further, there exists a long-felt need in the art for a fly fishing system that provides a fly fishing rod that can be easily threaded with a fly fishing line.

The subject matter disclosed and claimed herein, in one embodiment thereof, comprises a fly fishing system. The system is comprised of a body that can receive a fly fishing reel. The body can be secured to a belt of a user when in use such that the reel is supported without the use of the user's hands. In addition, the system is comprised of a telescopic fly fishing rod that is hollow such that a fishing line can be fed through the rod without the need for guides/eyelets found on traditional fly fishing rods. When not in use, the rod can be collapsed and stored on the body.

In this manner, the fly fishing system of the present invention accomplishes all the foregoing objectives and provides a fly fishing system that eliminates the need for a user to hold a fly reel while fly fishing and that ensures a fly reel is secure during use. Further, the system provides a fly fishing rod that is easily transportable and that can be easily threaded with a fly fishing line.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fly fishing system designed to allow a user to easily transport and use a fly fishing reel and fly fishing rod. The system is primarily comprised of a body that receives the reel, a support member that the reel attaches to, and the rod when the rod is not in use.

The body is comprised of at least one belt opening that allows a belt of a user to be run through the body such that the body hangs from the belt while in use. The body is also comprised of at least one recessed area that can receive a fly reel. While stored on the body, the fly reel is attached to and suspended from at least one support member, wherein the member is secured to the body via at least one fastener. In this manner, the support member also allows the reel to not be held in a user's hand during use.

The system may also be comprised of at least one fly fishing rod that is preferably telescopic such that it can expand while in use and retract in length when not in use. The rod is preferably hollow such that the fishing line stored around the reel can be fed through a first opening of a first end, through the body of the rod, and out an opening of a second end such that a user can use the rod to fly fish. When not in use, the rod can be attached to the support member via at least one fastener.

The present invention is also comprised of a method of using the device. First, a system is provided comprised of a body that receives a fly reel and a rod. Then, the fly reel can be attached to a support member which then can be secured to the body via a fastener. Then, the fly reel can be secured in a recessed area of the body. Then, a fishing line that surrounds the reel can be fed through the rod via inserting the line through a first opening of the rod and out a second opening through an eyelet. Next, the rod can be extended and locked into said extending position via a locking member. Then, the rod can be used to fly fish.

Accordingly, the fly fishing system of the present invention is particularly advantageous as it provides a fly fishing system that eliminates the need for a user to hold a fly reel while fly fishing and that ensures a fly reel is secure during use. Further, the system provides a fly fishing rod that is easily transportable and that can be easily threaded with a fly fishing line. In this manner, the fly fishing system overcomes the limitations of existing fly fishing methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a body of a fly fishing system of the present invention in accordance with the disclosed architecture;

FIG. 2 illustrates a side view of one potential embodiment of a body of a fly fishing system of the present invention while worn on a user's belt and while holding a rod in accordance with the disclosed architecture;

FIG. 3 illustrates a side perspective view of one potential embodiment of a body of a fly fishing system of the present invention while worn on a user's belt and wherein a user is holding a rod in accordance with the disclosed architecture;

FIG. 4 illustrates a side view of one potential embodiment of a rod of a fly fishing system of the present invention in accordance with the disclosed architecture; and

FIG. 5 illustrates a flowchart of a method of using one potential embodiment of a fly fishing system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fly fishing system. More specifically, there exists a long-felt need in the art for a fly fishing system that eliminates the need for a user to hold a fly reel while fly fishing. In addition, there exists a long-felt need in the art for a fly fishing system that ensures a fly reel is secure during use. Further, there exists a long-felt need in the art for a fly fishing system to have a fly fishing rod that is easily transportable. Further, there exists a long-felt need in the art for a fly fishing system that provides a fly fishing rod that can be easily threaded with a fly fishing line.

The present invention, in one exemplary embodiment, is comprised of a fly fishing system. The system allows a user to easily transport and use a fly fishing reel and fly fishing rod. The system is primarily comprised of a body that receives the reel, a support member that the reel attaches to, and the rod when the rod is not in use.

The body is comprised of at least one belt opening that allows a belt of a user to be ran through the body such that the body hangs from the belt while in use and need not be held in a user's hand during use. The body is also comprised of at least one recessed area that can receive a fly reel. While stored on the body, the fly reel is attached to and suspended from at least one support member, wherein the member is secured to the body via at least one fastener.

The system may also be comprised of at least one fly fishing rod. The rod is preferably telescopic such that it can expand while in use and retract in length when not in use. The rod is preferably hollow such that the fishing line stored around the reel can be fed through a first opening of a first end, through the body of the rod, and out an opening of a second end such that a user can use the rod to fly fish. When not in use, the rod can be attached to the support member via at least one fastener.

The present invention is also comprised of a method of using the device. First, a system is provided comprised of a body that receives a fly reel and a rod. Then, the fly reel can be attached to a support member which then can be secured to the body via a fastener. Then, the fly reel can be secured in a recessed area of the body. Then, a fishing line that surrounds the reel can be fed through the rod via inserting the line through a first opening of the rod and out a second opening through an eyelet. Next, the rod can be extended and locked into said extending position via a locking member. Then, the rod can be used to fly fish.

Accordingly, the fly fishing system of the present invention is particularly advantageous as it provides a fly fishing system that eliminates the need for a user to hold a fly reel while fly fishing and that ensures a fly reel is secure during use. Further, the system provides a fly fishing rod that is easily transportable and that can be easily threaded with a fly fishing line.

In this manner, the fly fishing system overcomes the limitations of existing fly fishing methods and devices known in the art.

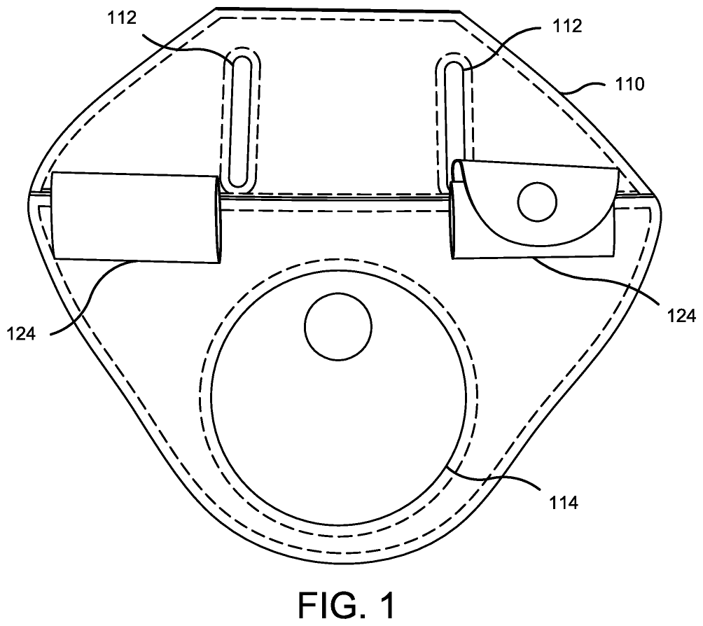

Referring initially to the drawings, FIG. 1 illustrates a top view of one potential embodiment of a body of a fly fishing system 100 of the present invention in accordance with the disclosed architecture. The system 100 is designed to allow a user to easily transport and use a fly fishing reel 120 and fly fishing rod 130. The system 100 is primarily comprised of a body 110 that receives the reel 120, a support member 122 that the reel 120 attaches to, and the rod 130 when the rod 130 is not in use.

The body 110 is preferably made from a leather material in one embodiment. However, the body 110 may be made of any flexible or rigid material known in the art. In one embodiment, the leather is comprised of waterproof leather to protect the body 110 while being worn to fly fish in a body of water.

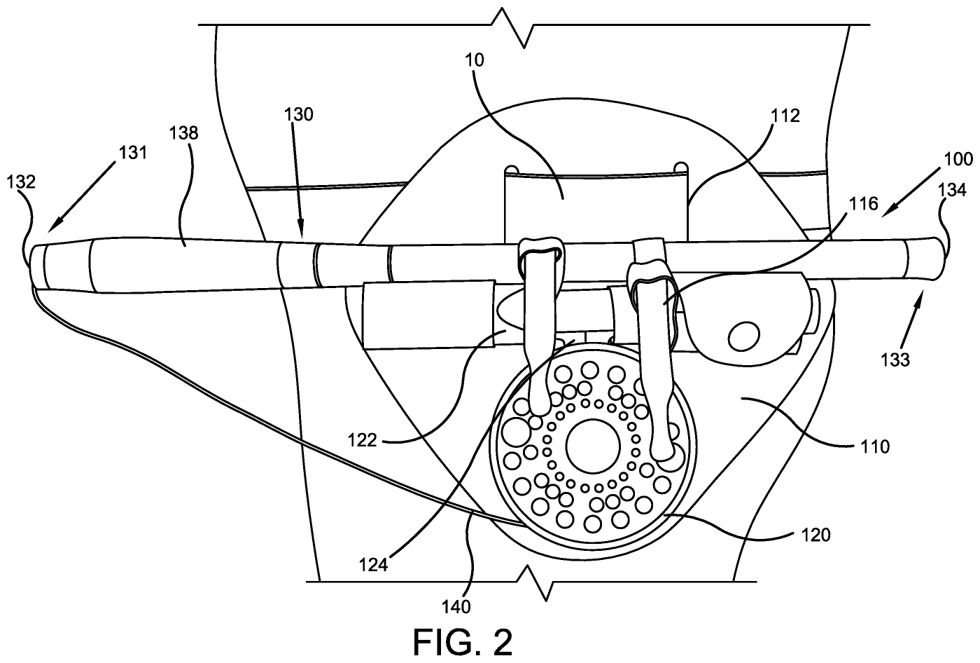

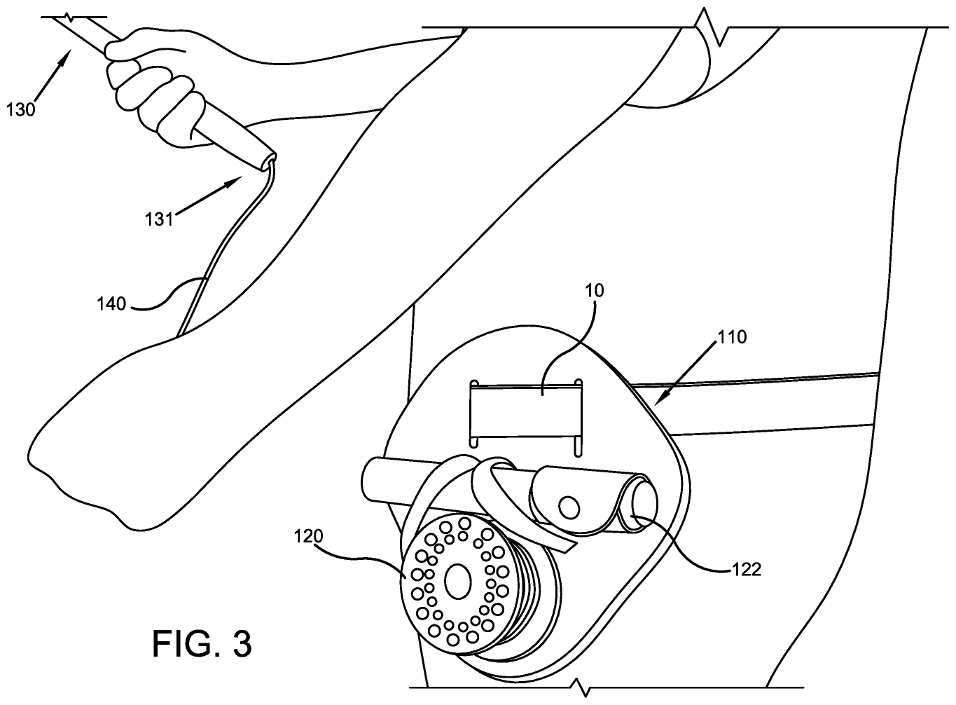

The body 110 is comprised of at least one belt opening 112. The opening 112 allows a belt 10 of a user to be run through the body 110 such that the body 110 hangs from the belt 10 while in use, as seen in FIG. 2 and FIG. 3. In this manner, the body 110 is secured at all times to the user.

The body 110 is comprised of at least one recessed area 114. The recessed area 114 is preferably circular such that it can receive a fly reel 120. The recessed area 114 also prevents movement of the fly reel 120 while moving, walking, etc.

While stored on the body 110, the fly reel 120 is attached to and suspended from at least one support member 122. The fly reel 120 may be fixedly or removably attached to the support member 122 in different embodiments. The member 122 is preferably tubular. The member 122 is secured to the body 110 via at least one fastener 124 such as, but not limited to, a loop, a snap button faster, a magnet fastener, a hook and loop fastener, an opening in the body 110, etc. In this manner, the support member 122 and reel 120 can be removed from the body 110 as needed. The support member 122 also allows the reel 120 to not be held in a user's hand during use.

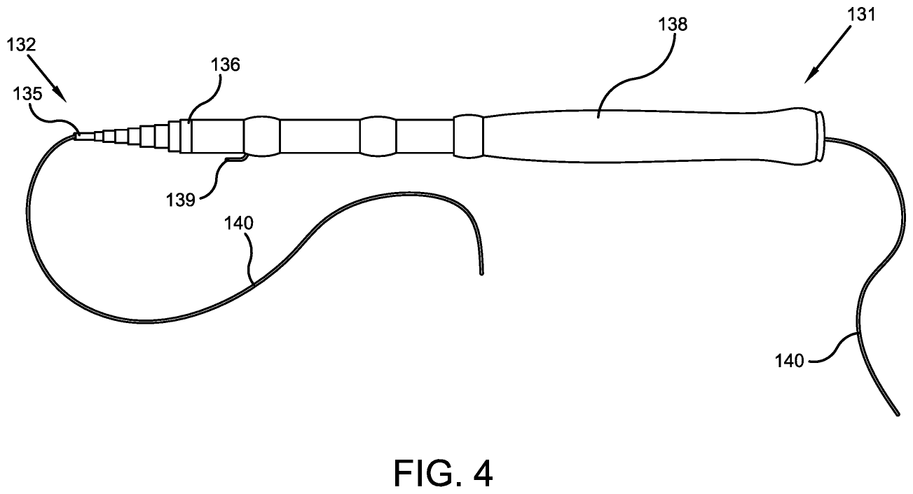

The system 100 may also be comprised of at least one fly fishing rod 130, as best seen in FIG. 4. The rod 130 is preferably telescopic such that it can expand while in use and retract in length when not in use. To allow the rod 130 to be secured at an extended or retracted position, the rod 130 is comprised of at least one locking member 136. The member 136 may be in the form of a twist, lock, button, etc. that secures the rod 130 at a specific length.

The rod 130 is preferably hollow such that fishing line 140 stored around the reel 120 can be fed through a first opening 132 of a first end 131, through the body of the rod 130, and out an opening 134 of a second end 133 such that a user can use the rod 130 to fly fish, as seen in FIG. 3 and FIG. 4. More specifically, the opening 134 may be comprised of at least one eyelet 135 that the line 140 is fed through for control purposes when using the rod 130. In addition, the body of the rod 130 may be comprised of at least one eyelet 139 (or other anchor point of the like) for a fly fishing hook and lure to attach to the rod 130. In this manner, a user can transport the rod 130 with the line 140 fully fed through the rod 130 and with an attached hook, ready to fly fish.

In addition, the rod 130 may be comprised of at least one grip area 138. The grip area 138 enhances a user's grip on the rod 130. The grip area 138 is preferably (but not limited to) comprised of a non-slip material such as rubber that may have a recessed or raised texture to improve grip.

When not in use, the rod 130 can be attached to the body 110. More specifically, the rod 130 can be attached to the support member 122 via at least one fastener 116 such as, but not limited to, a hook and loop strap, a snap button fastener, a magnet fastener, etc. In another embodiment, the fastener 116 is found on the body 110 itself and serves as a separate attachment point for the rod 130 that does not engage the support member 122.

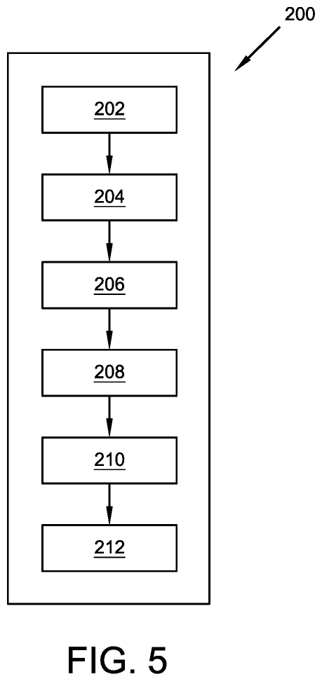

The present invention is also comprised of a method of using 200 the device 100, as seen in FIG. 5. First, a system 100 is provided comprised of a body 110 which receives a fly reel 120 and a rod 130 [Step 202]. Then, the fly reel 120 can be attached to a support member 122 which then can be secured to the body 110 via a fastener 116 [Step 204]. Then, the fly reel 120 can be secured in a recessed area 114 of the body 110 [Step 206]. Then, a fishing line 140 that surrounds the reel 120 can be fed through the rod 130 via inserting the line 140 through a first opening 132 of the rod 130 and out a second opening 134 through an eyelet 135 [Step 208]. Next, the rod 130 can be extended and locked into said extending position via a locking member 136 [Step 210]. Then, the rod 130 can be used to fly fish [Step 212].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “fly fishing system” and “system” are interchangeable and refer to the fly fishing system 100 of the present invention.

Notwithstanding the foregoing, the fly fishing system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fly fishing system 100 as shown in the FIGS. are for illustrative purposes only, and that many other sizes and shapes of the fly fishing system 100 are well within the scope of the present disclosure. Although the dimensions of the fly fishing system 100 are important design parameters for user convenience, the fly fishing system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fly fishing system comprising:
a body comprised of a recessed area and a body opening;
a fly reel;
a support member;
a fastener; and
a fly fishing rod comprised of a first rod opening and a rod second opening.

2. A fly fishing system of claim 1, wherein the fly reel is received by the recessed area.

3. A fly fishing system of claim 1, wherein the fly reel is suspended from the support member.

4. A fly fishing system of claim 1, wherein the fly fishing rod is comprised of a telescopic body.

5. A fly fishing system of claim 4, wherein the fly fishing rod is comprised of a locking member.

6. A fly fishing system of claim 1, wherein the fly fishing rod is comprised of an eyelet.

7. A fly fishing system of claim 1, wherein the fly fishing rod is comprised of a grip area.

8. A fly fishing system of claim 1, wherein the fastener is comprised of a hook and loop fastener.

9. A fly fishing system comprising:
a body comprised of a recessed area and a body opening and a body fastener;
a fly reel comprised of a fishing line;
a support member;
a fastener; and
a telescopic fly fishing rod comprised of a first rod opening and a rod second opening.

10. A fly fishing system of claim 9, wherein the fly reel is received by the recessed area.

11. A fly fishing system of claim 9, wherein the fly reel is suspended from the support member.

12. A fly fishing system of claim 9, wherein the fly fishing rod is comprised of a telescopic body.

13. A fly fishing system of claim 12, wherein the fly fishing rod is comprised of a locking member.

14. A fly fishing system of claim 9, wherein the fly fishing rod is comprised of an eyelet.

15. A fly fishing system of claim 9, wherein the fly fishing rod is comprised of a grip area.

16. A fly fishing system of claim 9, wherein the fastener is comprised of a hook and loop fastener.

17. A fly fishing system of claim 9, wherein the body fastener is comprised of a snap fastener.

18. A fly fishing system of claim 9, wherein the body fastener receives the support member.

19. A method of using a fly fishing system, the method comprising the following steps:
providing a fly fishing system comprised of a body, a fly reel, and a fly fishing rod;
securing the fly reel to a support member of the fly fishing system and securing the support member to the body;
securing the fly reel into a recessed area of the body;
feeding a fishing line of the fly reel through a first opening and a second opening of the fly fishing rod; and
using the fly fishing rod to fly fish.

20. A method of using a fly fishing system of claim 19, wherein the fly fishing rod is comprised of a telescopic fly fishing rod.
